(19) United States
(12) Patent Application Publication
(10) Pub. No.: US 2026/0369784 A1
(43) Pub. Date: Nov. 19, 2026

(54) MOUNTING BRACKET, MOUNTING SYSTEM, AND FUNCTIONAL UNIT

(71) Applicant: HELLA GMBH & CO. KGAA, Lippstadt (DE)

(72) Inventor: Francesco Canicatti, Erwitte (DE)

(21) Appl. No.: 19/675,918

(22) Filed: May 13, 2026

(30) Foreign Application Priority Data
May 15, 2025 (DE) 102025118753.3

(51) Int. Cl. H01M 50/249; H01M 50/262

(52) U.S. Cl. CPC H01M 50/249; H01M 50/262; H01M 2220/20

(57) ABSTRACT

The invention relates to a mounting bracket for mounting a housing of a functional unit in a vehicle. The mounting bracket includes a mounting region for fastening to the vehicle and a holding region for fastening to the housing. The invention further relates to a mounting system and a function unit.

### CROSS-REFERENCE TO RELATED APPLICATIONS

This application claims priority to German Patent Application 10-2025-118-753.3, filed May 15, 2025, the disclosure of which is incorporated by reference.

### FIELD OF THE INVENTION

The invention relates to a mounting bracket, a mounting system, and a functional unit.

### BACKGROUND OF THE INVENTION

In the field of mounting functional units in vehicles, it is common practice to provide housings with special fastening interfaces in order to connect them securely and reliably to the vehicle structure. Known systems typically comprise screw, plug, or clamp connections, which are designed to enable both stable fastening and easy mounting and dismounting. Particularly in the case of safety-relevant components or components requiring intensive maintenance, such as control devices, sensors, or battery modules, precise and repeatable mounting is of great importance. In this case, the brackets must meet various requirements, such as vibration resistance, tolerance compensation, corrosion protection, and the ability to compensate for manufacturing tolerances. In practice, standards generally specify the shape of the housing and also its fastening points. For this reason, the same geometry can always be provided for fastening to the vehicle as part of series production, even for different vehicle models.

However, in the design of modern vehicles, the installation space on the vehicle is increasingly being configured individually. At the same time, a particular type of functional unit, e.g. a particular type of battery, may be suitable for a plurality of vehicle models, in particular from different vehicle manufacturers.

### SUMMARY OF THE INVENTION

It is an object of the present invention to at least partially eliminate the above disadvantages known from the prior art. In particular, it is an object of the present invention to enable reliable, fast, and flexible mounting of functional units in vehicles while ensuring secure positioning and fixation. The above object is achieved by a mounting bracket, a mounting system, and a functional unit having the features set forth herein.

Further features and details of the invention are apparent from the respective dependent claims, the description, and the drawings. In this context, features and details which are described in connection with the mounting bracket according to the invention naturally also apply in connection with the mounting system according to the invention and/or the functional unit according to the invention, and vice versa in each case, so that reference is made or can always be made to the individual aspects of the invention reciprocally with regard to the disclosure.

According to a first aspect of the invention, a mounting bracket is provided for mounting a housing of a functional unit in a vehicle. The mounting bracket has a mounting region for fastening to the vehicle and a holding region for fastening to the housing. The holding region has at least two guide means, by which the holding region can be inserted into a mounting interface of the housing along a sliding direction, and a latching means, by means of which the holding region can be secured in the mounting interface, preferably in a form-fit manner, counter to the sliding direction.

In particular, the mounting bracket can be formed by a component that is provided separately from the housing. The housing may preferably be made of plastic. The functional unit may preferably comprise a vehicle battery, in particular with a battery management system. However, it is also conceivable that the functional unit comprises a control device and/or a sensor, the electronics of which are arranged in the housing.

The mounting region may protrude from the housing in the mounted state. This allows the mounting bracket to bridge a distance between the housing and the vehicle structure. Preferably, the mounting region is designed to be attached directly to the vehicle structure. The holding region is furthermore preferably designed to be attached directly to the housing, in particular by sliding it into the mounting interface.

The guide means may be configured in the manner of rails and/or may be formed by the edges of the holding region. The latching means may be arranged between the guide means. Preferably, the guide means may be elastically separated from the latching means. For example, a separating joint may be arranged between the latching means and each of the guide means in order to enable a relative movement of the latching means relative to the guide means.

The mounting interface may, for example, comprise an opening and/or recess. The sliding direction may be understood as a mounting direction along which the mounting bracket can be mounted on the housing by inserting the holding region into the mounting interface. The latching means may be designed to detachably or non-detachably secure the holding region in the mounting interface. For example, the latching means may be lifted in order to move past a counter-latching means when the holding region is inserted in and/or pulled out of the mounting interface.

This design enables a mounting procedure that can be carried out with little effort and high process reliability. At the same time, the mounting bracket enables simple adaptation of installation space-related dimensions by the mounting system. This means that the housing and/or the functional unit can also be manufactured as an identical part for different vehicle types. A further advantage may lie in the possibility of making the holding region detachable, so that dismounting or replacement of the functional unit is simplified. The mounting bracket thus contributes to a reduction in mounting times and to an increase in ease of maintenance, which is particularly important in vehicle construction.

Furthermore, in the case of a mounting bracket according to the invention, it may advantageously be provided that the latching means comprises an opening in which a counter-latching means of the mounting interface can be received in a form-fit manner. The counter-latching means may, for example, be configured as a latching pin that engages into the opening in the mounted state. The opening is preferably designed in such a manner that it can accommodate the counter-latching means, for example, in the form of a latching pin, in a form-fit manner. Form-fitting manner means that the two components interlock in such a manner that movement in one direction, in particular the withdrawal of the holding region from the mounting interface, is prevented by the geometric design of the connection. In this case, the counter-latching means is firmly arranged on the mounting interface of the housing and enters the latching means opening when the holding region is inserted, wherein the form-fit connection is established automatically. This mechanism between the latching means and the counter-latching means is used to securely fix the mounting bracket after it has been inserted into the mounting interface without any additional mounting work. The interaction between the opening and the counter-latching means also allows clear haptic or acoustic feedback during latching, which increases process reliability during mounting.

It is further conceivable in the case of a mounting bracket according to the invention that the mounting region has a fastening interface for a screw connection to the vehicle. In particular, the fastening interface comprises a region and/or a structure for mechanical connection between the mounting bracket and the vehicle. A screw connection ensures a particularly reliable and durable connection. In particular, the fastening interface is designed for receiving a fastening element, such as a screw, so that a form-fit and/or force-fit connection between the mounting bracket and a corresponding structure of the vehicle is made possible. Preferably, the fastening interface comprises an opening for the screw connection. The integration of such a fastening interface increases the flexibility during installation of the mounting bracket, as it can be adapted to different vehicle types and installation situations. In addition, the screw connection ensures high stability and vibration resistance of the connection, which is particularly important in the automotive environment with high demands on operational safety and durability. The possibility of designing the fastening interface as an opening allows a particularly space-saving and material-saving construction, as no additional fastening elements or complex shapes are required.

It is further conceivable in the case of a mounting bracket according to the invention that the holding region has a front portion which has an elastic ramp for the front portion to move past the counter-latching means, in particular without cutting, when the holding region is inserted into the mounting interface. The front portion may be understood as a portion of the holding region that is oriented in the sliding direction and/or is arranged within the mounting interface in the mounted state. The ramp may comprise an inclined surface and/or contour that enables the counter-latching means to be passed over, in particular gently and/or by sliding, without causing plastic deformation or damage to the components. For this purpose, the ramp may be adjusted relative to the mounting region by means of elastic deformation. The design of the front portion with the ramp results in a low-friction, force-optimized movement when the holding region is inserted into the mounting interface, as the ramp can be lifted or pressed aside by the counter-latching means without the need for a great deal of mounting effort or additional tools. Furthermore, damage or wear of the components involved is avoided by moving past the counter-latching means without cutting, which increases the service life of the mounting bracket and improves functional reliability. Another advantage is that the targeted design of the front portion with a ramp makes it easier to compensate for tolerances during assembly, which increases process reliability and reduces the requirements for manufacturing accuracy.

Within the scope of the invention, it is furthermore conceivable that the guide means each has at least one inlet region for sliding along a wall of the mounting interface without cutting. In this case, the inlet region may preferably be arranged in the front portion of the guide means and/or may be formed by a chamfer and/or a rounding. In particular, the inlet region is a specially designed portion of the guide means that makes the first contact with the wall of the mounting interface and, due to its shape, supports a smooth and low-resistance insertion of the holding region along the sliding direction. The wall of the mounting interface may be understood as an inner surface or boundary of the mounting interface into which the mounting bracket is inserted. The design of the inlet region as a chamfer or rounding effectively prevents tilting or blocking when the holding region is inserted. One advantage of this design is that mounting of the housing of the functional unit in the vehicle can be carried out with less effort and less risk of damage to the components involved. A further advantage can be improved process reliability, as the risk of mounting errors, for example, due to incorrect positioning or tilting, is reduced.

It is further conceivable in the case of a mounting bracket according to the invention that the mounting region and the holding region are formed from a common molded part and/or are adjustable relative to one another by means of a bend. The common-shaped part can be realized, for example, as a sheet-metal part, stamped part, and/or plastic part. In particular, the mounting region and the holding region may be integral parts of a single component. This leads to a reduction in the number of components and enables particularly economical production, as there is no need for additional connecting elements or separate production steps. The possibility of adjusting the mounting region and the holding region in relation to one another by means of a bend allows flexible adaptation to different installation situations in the vehicle. In particular, the bend may be designed so that the angle or the relative position of the two regions can be specifically changed to compensate for tolerances in the vehicle body structure or in the housing of the functional unit. This is particularly advantageous if different vehicle models or installation locations are to be covered with a single mounting bracket. Production as a sheet-metal part and/or stamped part enables cost-effective series production with high precision, while the realization as a plastic part permits a high degree of design freedom and low weight.

Furthermore, in the case of a mounting bracket according to the invention, it is conceivable that the holding region can be inserted into the mounting interface in a mounting plane, wherein the mounting region and the holding region are offset relative to one another, as a result of which the mounting region is offset relative to the mounting plane. The mounting plane may be understood as a plane along which the holding region is guided during the insertion into the mounting interface, in particular, so that targeted and controlled positioning of the holding region in the housing of the functional unit is made possible. The offset may comprise a spatial displacement and/or arrangement of the mounting region relative to the mounting plane, so that the mounting region is not arranged in the same plane as the holding region, but may instead be positioned, for example, parallel to and/or at a certain distance from the mounting plane. This offset allows flexible adaptation to different installation situations in the vehicle, in particular if space is limited or there are geometric restrictions in the region of the vehicle structure.

Within the scope of the invention, it is furthermore conceivable that a clamping means is arranged on the holding region, in particular on at least one of the guide means, for clamping the holding region in the mounting interface. Preferably, a clamping means is arranged on each guide means for clamping the holding region in the mounting interface. The clamping means may comprise a mechanical element that serves to achieve an additional fixation between the holding region and the mounting interface by means of a clamping action. For example, the clamping means may be configured as a resilient element, a projection, and/or a form-fit component, which is placed in a pre-stressed state when the holding region is inserted into the mounting interface, thereby generating a frictional force and/or a clamping force. Preferably, the clamping means for clamping the holding region acts perpendicular to the sliding direction. One advantage of such a clamping means is that increased vibration resistance can be achieved, as the clamping means effectively prevents unwanted relative movements between the holding region and the housing. In addition, a clamping means may compensate for manufacturing tolerances by compensating for small dimensional deviations between the holding region and the mounting interface, thus enabling mounting without play. The integration of the clamping means on the guide means also enables a particularly compact design, as no separate fastening elements are required, and mounting can be carried out in a single operation.

According to a further aspect of the invention, a mounting system for a functional unit of a vehicle is provided. The mounting system has a housing for the functional unit and at least one mounting bracket according to the invention. The housing has at least one mounting interface into which the mounting bracket is inserted.

Thus, a mounting system according to the invention has the same advantages as those already described in detail with reference to a mounting bracket according to the invention. The housing may preferably be designed as a plastic part. The mounting interface may comprise an opening into which the mounting bracket is inserted. Preferably, the mounting interface is integral with the housing.

Within the scope of the invention, it is furthermore conceivable that the mounting interface forms an insertion compartment that has at least two lateral counter guides, each of which is designed to guide one guide means of the mounting bracket. The lateral counter guides enable precise and play-free guidance of the mounting bracket when it is inserted into the insertion compartment. The insertion compartment may be understood as a region of the housing of the functional unit that is designed such that the mounting bracket can be received in the sliding direction. The lateral counter guides may be formed by grooves, rails, and/or ribs. Preferably, the counter guides have a U-shaped profile in which one guide means of the mounting bracket can be guided in each case. The interaction between the guide means of the mounting bracket and the counter guides of the insertion compartment enables a defined relative movement that ensures precise orientation and positioning of the functional unit in the vehicle. One advantage of this design is improved mounting accuracy, as the guiding forces are specifically absorbed and transverse forces are intercepted during the insertion procedure, which prevents the mounting bracket from tilting or jamming in the insertion compartment. The design of the mounting interface as an insertion compartment with lateral counter guides thus contributes to robust, repeatable, and fast mounting and supports the automation of the mounting process, since the guiding elements may have a self-centering effect.

Furthermore, in the case of a mounting system according to the invention it may advantageously be provided that the mounting interface comprises a counter-latching means for form-fit securing of the mounting bracket, wherein the counter-latching means has a counter ramp that can be moved past without cutting by a front portion of the mounting bracket when the holding region is inserted into the mounting interface. The counter ramp may be designed to correspond to the ramp. For example, the counter ramp and the ramp may each have a surface that has a corresponding angle relative to one another when the holding region is inserted into the mounting interface. It is conceivable that the ramp and the counter ramp are aligned parallel or substantially parallel to one another when the holding region is being inserted into the mounting interface, at least before the latching means moves past the counter-latching means. The latching means may, for example, be designed as a resilient element that can be slid over the counter ramp and is elastically deformable. One advantage of this design is that the mounting and dismounting of the functional unit in the vehicle can be carried out without tools and with little effort.

Within the scope of the invention, it is furthermore conceivable that the housing has a plurality of identical mounting interfaces for receiving one mounting bracket each. The identical mounting interfaces can be understood to mean identically designed interfaces on the housing, in particular those that are designed in such a manner that they can interact with a mounting bracket of the same design. This arrangement allows a plurality of mounting brackets to be attached at different positions of the housing, wherein each mounting interface can be used independently of the others. In this case, the mounting brackets may be designed as identical parts and/or may have an identical holding region. One advantage of such a design is the increased variability when integrating the functional unit into different vehicle types or vehicle regions, as the number and position of the mounting brackets can be selected as required. In addition, the use of a plurality of identical mounting interfaces improves ease of mounting, as mounting procedures can be standardized and simplified.

According to a further aspect of the invention, a functional unit in the form of a vehicle battery for a vehicle is provided. The functional unit has a mounting system according to the invention.

Thus, a functional unit according to the invention has the same advantages as those already described in detail with reference to a mounting bracket according to the invention and/or a mounting system according to the invention. The vehicle battery may, for example, be a starter battery and/or a traction battery for the vehicle.

### DESCRIPTION OF THE DRAWINGS

The invention is explained in more detail below with reference to the accompanying drawings. In the drawings:

FIG. 1 is a mounting system having a housing and a mounting bracket;

FIG. 2 is the mounting system having a plurality of mounting brackets;

FIG. 3 is one of the mounting brackets;

FIG. 4 is a mounting interface for the mounting bracket;

FIG. 5 is a cross-section of the mounting system with the mounting bracket mounted; and

FIG. 6 is a vehicle having a functional unit in the form of a vehicle battery that has the mounting system.

### DETAILED DESCRIPTION OF THE CURRENT EMBODIMENTS

In the following description of several exemplary embodiments of the invention, identical reference signs are used to designate the same technical features, even across different exemplary embodiments.

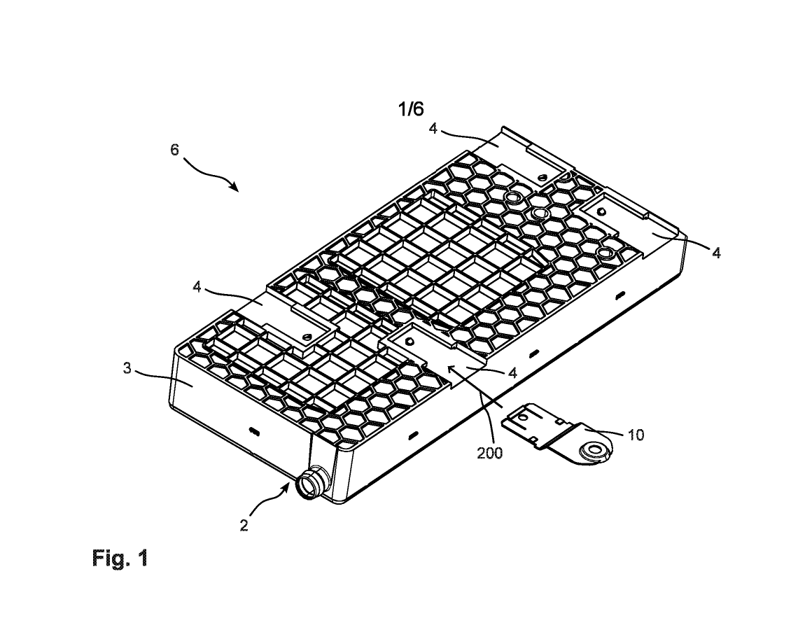

FIG. 1 shows a mounting system 6 for a functional unit 2, here in the form of a vehicle battery, of a vehicle 1 in a first exemplary embodiment. The mounting system 6 comprises a housing 3 for the functional unit 2. Preferably, the housing 3 forms a battery housing for the vehicle battery. Furthermore, the mounting system 6 comprises at least one mounting bracket 10 for mounting the housing 3 in the vehicle 1 and at least one mounting interface 4, into which the mounting bracket 10 is inserted. In the present exemplary embodiment, the housing 3 comprises a plurality of identical mounting interfaces 4, each for receiving one mounting bracket 10.

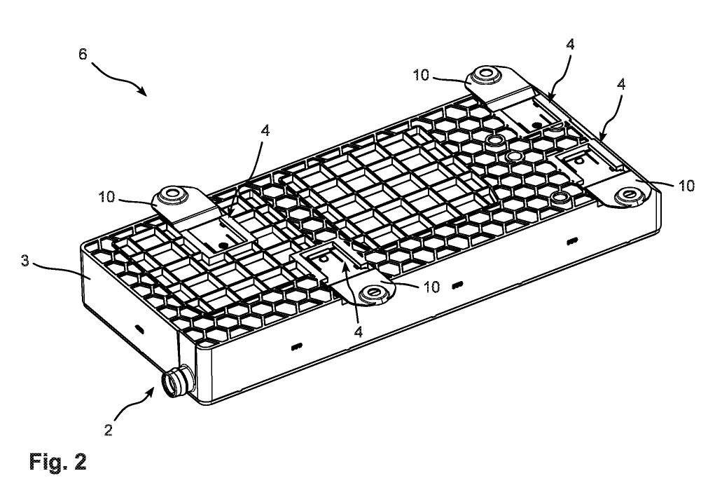

The mounting brackets 10 are shown in the inserted state, i.e., in particular in the mounted state, in FIG. 2.

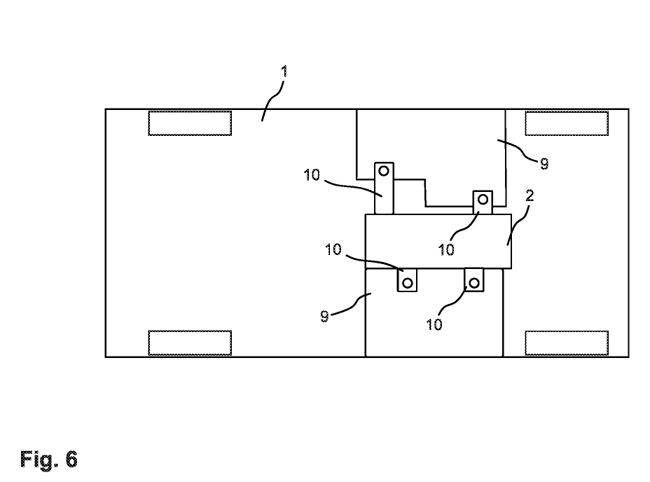

FIG. 6 shows vehicle 1 having the functional unit 2 in the form of a vehicle battery. As can also be seen from FIG. 6, the mounting brackets 10 may have different lengths in order to be fastened to a vehicle structure 9 of the vehicle 1. Preferably, however, the mounting brackets 10 are of identical design.

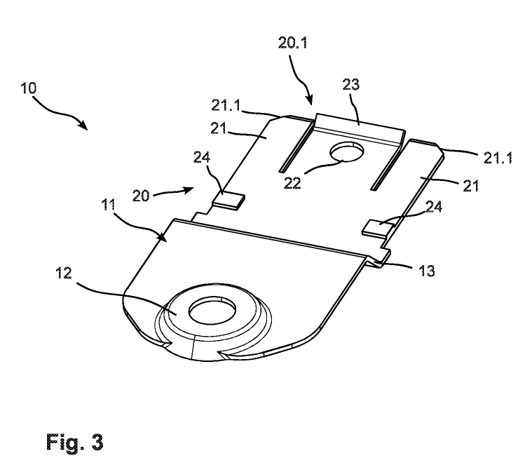

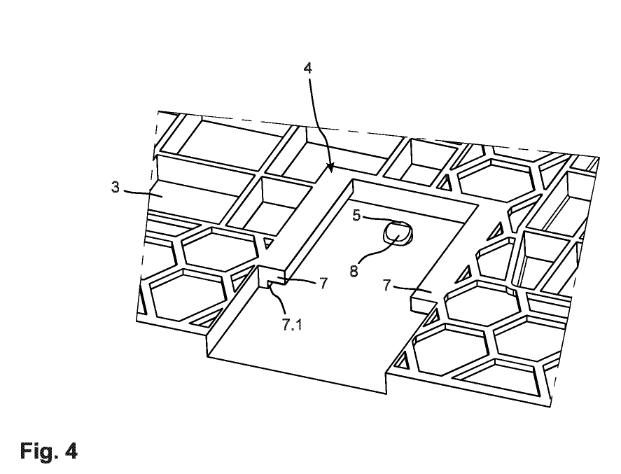

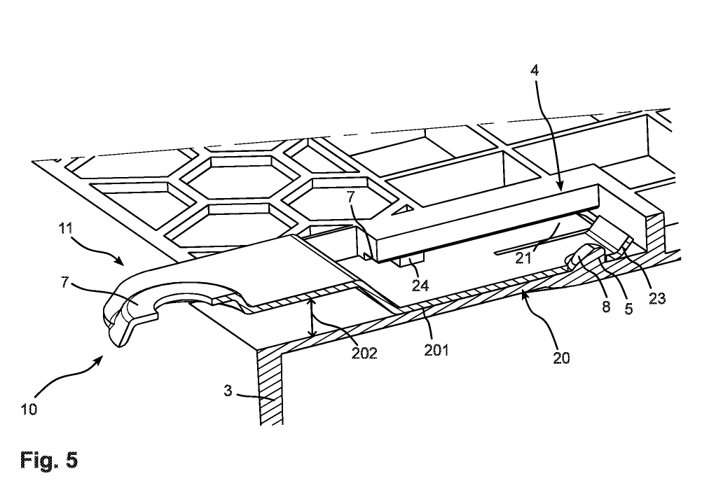

One of the mounting brackets 10 is shown separately in FIG. 3 and in the inserted state in one of the mounting interfaces 4 in FIG. 5. The mounting interface 4 is shown separately in FIG. 4. The mounting bracket 10 has a mounting region 11 for fastening to the vehicle 1. The mounting region 11 may comprise, for example, a fastening interface 12 for a screw connection to the vehicle 1. The mounting bracket 10 has a holding region 20 for fastening to the housing 3.

The holding region 20 has at least two guide means 21, by means of which the holding region 20 can be inserted into the mounting interface 4 along a sliding direction 200 as shown in FIG. 1. For this purpose, the mounting interface 4 forms an insertion compartment that has at least two lateral counter guides 7, each of which is designed to guide a guide means 21 of the mounting bracket 10. The guide means 21 each has at least one inlet region 21.1 for sliding along a wall 7.1 of the mounting interface 4 without cutting. Furthermore, a clamping means 24 for clamping the holding region 20 in the mounting interface 4 is arranged on the holding region 20, preferably on each of the guide means 21.

Furthermore, the holding region 20 comprises a latching means 22, by means of which the holding region 20 can be secured in the mounting interface 4 against the sliding direction 200. The latching means 22 comprises an opening in which a counter-latching means 5 of the mounting interface 4 can be received in a form-fit manner. The holding region 20 further has a front portion 20.1, which comprises an elastic ramp 23 for the front portion 20.1 to move past the counter-latching means 5 without cutting when the holding region 20 is inserted into the mounting interface 4. The counter-latching means 5 comprises a counter ramp 8, which can be moved past by the front portion 20.1 without cutting when the holding region 20 is inserted into the mounting interface 4. In this case, the ramp 23 and the counter ramp 8 interact with one another.

The mounting region 11 and the holding region 20 of the mounting bracket 10 are formed from a common molded part. Furthermore, the mounting region 11 and the holding region 20 are preferably adjustable in relation to one another by means of a bend 13. As shown in FIG. 5, the mounting region 11 and the holding region 20 may have an offset 202 relative to one another, by means of which the mounting region 11 is offset relative to a mounting plane 201 of the holding region 20. As a result, it is not necessary for the fastening interface 12 to be fastened to the vehicle structure 9 in the mounting plane 201.

The foregoing explanation of the embodiments describes the present invention solely by way of examples. It is understood that individual features of the embodiments can be freely combined with one another, provided this makes technical sense, without departing from the scope of the present invention.

List of reference signs:
1 vehicle
2 functional unit
3 housing
4 mounting interface
5 counter-latching means
6 mounting system
7 counter guides
7.1 wall
8 counter ramp
9 vehicle structure
10 mounting bracket
11 mounting region
12 fastening interface
13 bend
20 holding region
20.1 front portion
21 guide means
21.1 inlet region
22 latching means
23 ramp
24 clamping means
200 sliding direction
201 mounting plane
202 offset

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A mounting bracket for mounting a housing of a functional unit in a vehicle, comprising:
a mounting region configured for fastening to the vehicle; and
a holding region configured for fastening to the housing, wherein the holding region has at least two guide means configured such that the holding region can be inserted into a mounting interface of the housing along a sliding direction, and a latching means configured such that the holding region can be secured in the mounting interface counter to the sliding direction.

2. The mounting bracket of claim 1, wherein the latching means comprises an opening configured to receive a counter-latching means of the mounting interface in a form-fit manner.

3. The mounting bracket of claim 1, wherein the mounting region has a fastening interface configured for a screw connection to the vehicle.

4. The mounting bracket of claim 2, wherein the holding region has a front portion that includes an elastic ramp configured to allow the front portion to move past the counter-latching means without cutting when the holding region is inserted into the mounting interface.

5. The mounting bracket of claim 1, wherein each guide means has at least one inlet region configured for sliding along a wall of the mounting interface without cutting.

6. The mounting bracket of claim 1, wherein the mounting region and the holding region are formed from a common molded part or are adjustable relative to one another by a bend.

7. The mounting bracket of claim 1, wherein the holding region is configured to be inserted into the mounting interface in a mounting plane, and wherein the mounting region and the holding region have an offset relative to one another such that the mounting region is offset relative to the mounting plane.

8. The mounting bracket of claim 1, wherein a clamping means is arranged on the holding region and is configured to clamp the holding region in the mounting interface.

9. A mounting system for a functional unit of a vehicle, comprising:
a housing for the functional unit; and
at least one mounting bracket according to claim 1, wherein the housing has at least one mounting interface into which the mounting bracket is inserted.

10. The mounting system of claim 9, wherein the mounting interface forms an insertion compartment having at least two lateral counter guides, each configured to guide one guide means of the mounting bracket.

11. The mounting system of claim 9, wherein the mounting interface comprises a counter-latching means configured to secure the mounting bracket in a form-fit manner, and wherein the counter-latching means has a counter ramp configured to be passed without cutting by a front portion of the mounting bracket when the holding region is inserted into the mounting interface.

12. The mounting system of claim 9, wherein the housing has a plurality of identical mounting interfaces, each configured to receive one mounting bracket.

13. A functional unit in the form of a vehicle battery for a vehicle, comprising a mounting system according to claim 9.
